(19) United States
(12) Patent Application Publication
(10) Pub. No.: US 2007/0062443 A1
(43) Pub. Date: Mar. 22, 2007

(54) Biochip production apparatus

(75) Inventors: Takeo Tanaami, Tokyo (JP); Saya Satou, Toyo (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION

(21) Appl. No.: 11/221,874

(22) Filed: Sep. 9, 2005

(30) Foreign Application Priority Data
Sep. 10, 2004 (JP) P.2004-263218

(51) Int. Cl. B05C 5/00; B05B 7/06

(52) U.S. Cl. 118/305; 118/313

(57) ABSTRACT

A biochip production apparatus, which forms an array of biopolymers on a substrate, has a substrate moving unit which moves the substrate up, down, left and right, and a plurality of solution supply units which are disposed to be fixed, in which solutions containing biopolymers are stored, which deposit the solutions on the substrate. When the solution supply units deposit the solutions on a predetermined position of the substrate, the substrate moving unit moves the substrate to a predetermined position.

### CROSS-REFERENCE TO RELATED APPLICATIONS

This application is based upon and claims the benefit of priority from the prior Japanese Patent Applications No. 2004-263218, filed on Sep. 10, 2004, the entire contents of which are incorporated herein by reference.

### BACKGROUND OF THE INVENTION

1. Field of the Invention

The present invention relates to a biochip production apparatus for producing a biochip.

2. Description of the Related Art

A biochip in which biopolymers such as DNA, protein, etc. are fixed at high density has appeared. For example, this type biochip is formed so that tens to tens of thousands of heterogenous biopolymers are arranged on a substrate.

JP-A-2002-243736 is referred to as a related art of a method of producing a biochip by arranging biopolymers on a substrate.

FIG. 8 is a partly schematic view of a dispensing device for achieving the biochip producing method described in JP-A-2002-243736. The dispensing device 1 includes a reagent dispenser 2 having an elongate open capillary channel 4. The capillary channel 4 is made from a pair of long and narrow members 2a and 2b. The members 2a and 2b approach each other so that the capillary channel 4 is tapered off to a tip of a lower end of the channel 4, that is, to a tip region 3 of the channel 4. A certain amount of a reagent solution 5 is held in the tip region 3.

The reagent dispenser 2 is connected to a connection member 8 so that the reagent dispenser 2 can also move up and down in accordance with the up/down motion of a solenoid piston 7 of a solenoid 6. The solenoid 6 is connected to an arm 9 so that the dispensing device 1 as a whole can be moved up, down, left and right to a predetermined position suitably by the arm 9.

As shown in FIG. 9, the dispensing device 1 is attached to a dispensing device cage. While the dispensing device 1 comes near to or goes away from a dispensing position, the tip of the dispensing device 1 softly touches a surface of a support 210 so that the solution at the tip of the reagent dispenser 2 can be dispensed. Detailed description will be made below.

The dispensing device 1 is moved in an X-axis (horizontal) direction by a worm screw 80. The worm screw 80 is driven to rotate by a stepper motor 82 controlled by a control unit 77. The stepper motor 82 is attached to a sleeve 86 at one end of the worm screw 80. The other end of the worm screw 80 is rotatably supported by a sleeve 84.

One sleeve 86 is fitted onto a fixed rod 88 mounted between a pair of frame bars 90 and 92 while the other sleeve 84 is fitted onto a worm screw 94 rotatably mounted between a pair of frame bars 96 and 98. The worm screw 94 is driven to rotate by a stepper motor 99 controlled by the control unit 77. The rotations of the worm screws 80 and 94 are controlled in this manner so that the worm screw 80 as a whole is moved in a Y-axis (vertical) direction.

According to this configuration, the position of the dispensing device 1 can be decided as an arbitrary position in the X-axis and Y-axis directions so that the solution in the dispensing device 1 can be spotted on a surface of a support (e.g. biochip) 210.

The above method however has the following problem.

Although reduction in weight of the reagent dispenser 2 is preferably required for improving the speed of the operation for spotting, a solution reservoir for reserving the reagent solution needs to be provided separately so that the reagent dispenser 2 can go to the solution reservoir as a supply base if reduction in weight of the reagent dispenser 2 is attained. In this case, both operation and structure are complicated so that a long time is taken, and that the reagent dispenser 2 is apt to be dried. There is therefore a problem that an inhomogeneous site is generated because the amount of the spot is not uniform.

### SUMMARY OF THE INVENTION

An object of the invention is to provide a biochip production apparatus in which solutions can be supplied directly to spotting pins (hereinafter referred to as “pins” simply) to attain improvement in speed, simplification in structure and uniformity in amount of a spot on each site simultaneously.

The invention provides a biochip production apparatus for forming an array of biopolymers on a substrate, having: a substrate moving-unit which moves the substrate up, down, left and right; and a plurality of solution supply units which are disposed to be fixed, in which solutions containing biopolymers are stored, which deposit the solutions on the substrate.

In the biochip production apparatus, when the solution supply units deposit the solutions on a predetermined position of the substrate, the substrate moving unit moves the substrate to a predetermined position.

According to this configuration, when the substrate is moved without moving the solution supply units, the array of biopolymers can be formed on the substrate. It is easy to improve the moving speed of the substrate. According to the biochip production apparatus, the speed of the operation for spotting can be therefore improved easily. Both structure and operation for solution supply are easy and simple. In addition, a proper quantity of solution can be deposited easily on the substrate at the time of spotting. As a result, a homogeneous site can be formed easily.

In the biochip production apparatus, the substrate moving unit has a stage, on which the substrate is disposed, which enables to move up, down, left and right.

In the biochip production apparatus, each of the solution supply units stores solutions containing biopolymers different in kind, respectively.

In the biochip production apparatus, the substrate is located in an upper or lower side of each solution supply unit.

In the biochip production apparatus, each of the solution supply units has a syringe or a needle which enables to supply the solutions with using capillarity.

In the biochip production apparatus, each of the solution supply units deposits the solutions on the substrate at a point or at multi-points.

In the biochip production apparatus, a pitch of the multi-points on the substrate is not larger than 1 mm.

In the biochip production apparatus, the solution supply units deposit the solutions on the substrate by a mechanical contact method, an ink jet method, or an electrostatic adsorption method.

The invention also provides a biochip production apparatus, wherein solutions on a substrate deposited by another biochip production apparatus, which is mentioned above, are transferred onto another substrate to form an array of biopolymers.

The following advantages can be obtained in accordance with the biochip production apparatus.

(1) When only the substrate is moved to a predetermined position while each solution supplier is fixed, the solution in the solution supplier can be spotted on a surface of the substrate. On this occasion, the biochip production apparatus can perform the operation for spotting particularly at a higher speed than the biochip production apparatus as the prior art.

(2) Because there is no moving mechanism in the solution supply unit, the biochip production apparatus is simpler in structure than the biochip production apparatus as the prior art.

(3) Because each solution supplier is formed so that an adequate quantity of solution can be always supplied to the substrate, a uniform amount of solution can be spotted so that a homogeneous site can be formed easily.

### BRIEF DESCRIPTION OF THE DRAWINGS

FIG. 1 is a configuration diagram of important part showing a biochip production apparatus as an embodiment of the invention;

FIG. 2 is a view showing an example of spotting due to the biochip production apparatus depicted in FIG. 1;

FIG. 3 is a configuration diagram of important part showing another embodiment of the invention;

FIG. 4 is a configuration diagram of important part showing a solution supplier as another embodiment of the invention;

FIGS. 5A and 5B are configuration diagrams of important part showing a further embodiment of the invention;

FIGS. 6A and 6B are configuration diagrams of important part showing a further embodiment of the invention;

FIG. 7 is a configuration diagram of important part showing a further embodiment of the invention;

FIG. 8 is a configuration diagram showing an example of a dispensing device for achieving a background-art biochip producing method; and

FIG. 9 is a view showing the configuration of a portion in which the dispensing device depicted in FIG. 8 is mounted.

### DETAILED DESCRIPTION OF THE PREFERRED EMBODIMENTS

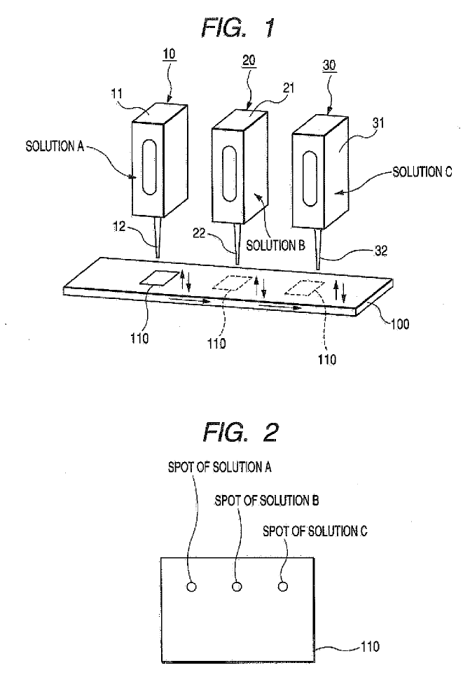

Embodiments of the invention will be described below in detail with reference to the drawings. FIG. 1 is a configuration diagram of important part showing a biochip production apparatus as an embodiment of the invention. As shown in FIG. 1, the biochip production apparatus of the embodiment has solution suppliers 10, 20 and 30, a stage 100; and a substrate 110.

The solution supplier 10 has a solution supply portion 11 and a pin 12. The solution supply portion 11 is formed so that a biopolymer-containing solution can be reserved in the solution supply portion 11 and can be supplied to the pin 12. The pin 12 is shaped like a needle and has a structure in which a base portion of the pin 12 is connected to the solution supply portion 11 so that the solution in the solution supply portion 11 is led to a tip portion of the pin 12.

Each of the other solution suppliers 20 and 30 has the same configuration as that of the solution supplier 10. These solution suppliers are connected and fixed by a support member not shown so that the solution suppliers are arranged at regular intervals.

The stage 100 is shaped like a plate and formed so that the stage 100 as a whole can be moved up, down, left and right by a known moving mechanism. The substrate 110 is detachable attached onto the stage 100.

According to this configuration, when only the stage 100 is moved up, down, left and right suitably while the solution supplier 10 is fixed, solutions led to the tip portions of the pins 12, 22 and 32 (represented by the pin 12) can be spotted on desired positions of the substrate 110, respectively.

Assume now that the solution supplier 10 is filled with a kind A of solution (hereinafter referred to as “solution A”), the solution supplier 20 is filled with a kind B of solution (hereinafter referred to as “solution B”) and the solution supplier 30 is filled with a kind C of solution (hereinafter referred to as “solution C”) as shown in FIG. 1.

(1) The stage 100 is moved to a predetermined position so that a place of the substrate 110 on which the solution A will be deposited comes just under the pin 12. Then, the stage 100 is moved up so that the solution A is spotted on the surface of the substrate 110 in the condition that the substrate 110 abuts on the tip portion of the pin 12. Incidentally, the moving speed of the stage 100 can be changed so suitably that the stage 100 can come near to or go away from the pin 12 rapidly particularly at the time of spotting.

After spotting, the stage 100 is moved down to a predetermined position so that the substrate 110 can be sufficiently far from the pin 12.

(2) Then, the stage 100 is moved to a predetermined position in the same manner as described above, so that the solution B is spotted on the predetermined position of the substrate 110.

(3) Then, the stage 100 is moved to a predetermined position by the same operation as described above, so that the solution C is spotted on the predetermined position of the substrate 110.

In this manner, an array of biopolymers formed from the solutions A, B and C deposited on one substrate 110 can be provided as shown in FIG. 2.

As described above, in accordance with the embodiment, both structure and operation are simpler and speedier than those in the background-art biochip production apparatus in which the reagent dispenser is moved up, down, left and right for spotting. Moreover, an array of biopolymers excellent in uniformity of spotting (homogeneity of the site) can be formed.

Particularly a biochip substrate for clinical examination has about 100 sites whereas a biochip substrate for research has tens of thousands of sites. Accordingly, the biochip production by the biochip production apparatus according to the invention is very useful practically.

The invention is not limited to the above embodiment and may include various changes and modifications without departing from the spirit of the invention.

For example, the number of solution suppliers is not limited to three described in the above embodiment but may be changed if necessary.

Although the embodiment has been described on the case where one substrate 110 is put on the stage 100 by way of example, the invention may be applied to the case where a plurality of substrates 110 are arranged simultaneously on the stage 110 like a belt conveyer and the stage 110 is moved suitable in order to perform spotting. The latter is a method very suitable for mass production.

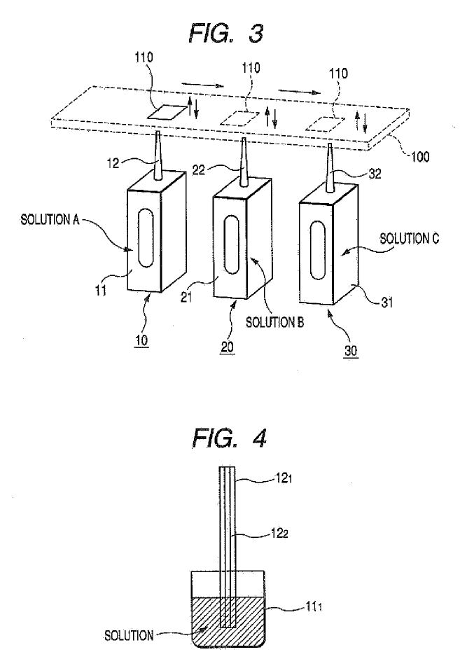

The substrate 110 and the solution suppliers 10, 20 and 30 may be turned upside down as shown in FIG. 3 with respect to the embodiment. For example, a syringe may be used as each of the solution suppliers 10, 20 and 30. Otherwise, a needle 12, having a capillary 12₂ formed therein as shown in FIG. 4 may be used so that a lower end portion of the needle 12₁ is immersed in a solution in a vessel 11, and that the solution is sucked up to an upper end of the needle by the capillary 12₂.

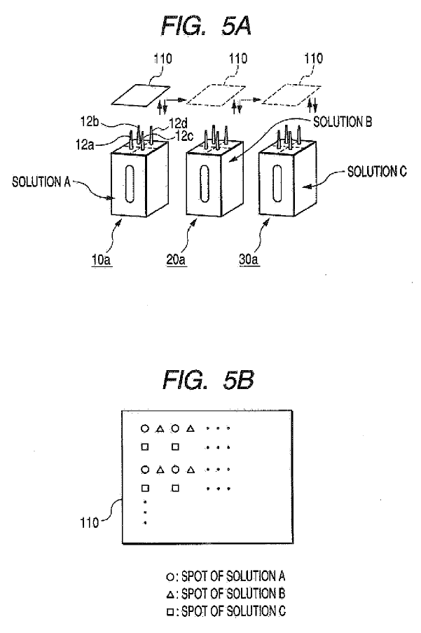

As shown in FIG. 5A, a plurality of pins 12a, 12b, 12c and 12d may be provided in each of the solution suppliers so that a plurality of spottings may be performed simultaneously on the substrate 110. FIG. 5B is a view showing a result of the spottings. In FIG. 5B, the symbol ◯ designates a spot of the solution A due to the solution supplier 10a, the symbol Δ designates a spot of the solution B due to the solution supplier 20a, and the symbol □ designates a spot of the solution C due to the solution supplier 30a. As is obvious from FIG. 5B, the operation for spotting becomes easy when the interval (pitch) of the pins is widened.

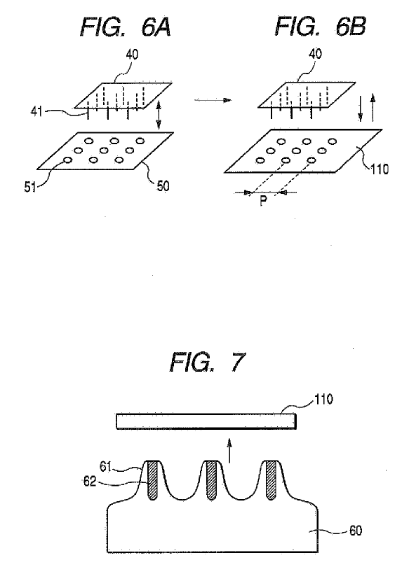

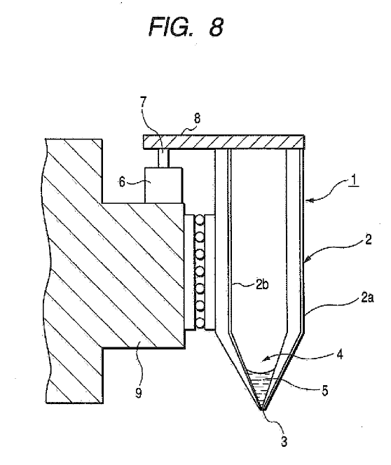

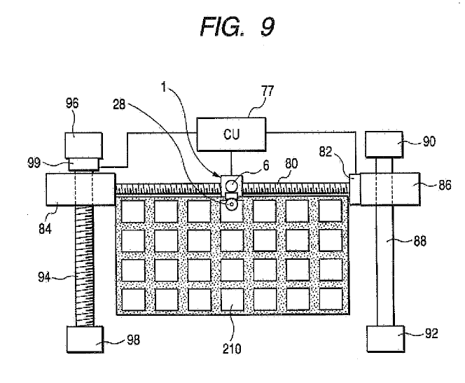

FIGS. 6A and 6B are views showing another method for depositing solutions. In FIGS. 6A and 6B, the reference numeral 40 denotes a multi-pin implanted body in which a plurality of pins 41 are implanted; and the reference numeral 50 denotes a solution supply portion having a plurality of solution reservoir portions 51 provided at intervals of the same pitch as the implanting pitch of the pins 41. The multi-pin implanted body 40 is formed so that the multi-pin implanted body 40 can move up, down, left and right relative to the solution supply portion 50 and the substrate 110.

In this configuration, solutions are injected in the solution reservoir portions 51 in advance, for example, by a method shown in FIG. 1. As shown in FIG. 6A, the multi-pin implanted body 40 is moved down so that the tip portions of the all pins 41 are immersed in the solution reservoir portions 51 respectively. In this manner, the solutions are deposited on the pins 41 respectively. Then, the multi-pin implanted body 40 is moved up and moved laterally to just above the substrate 110. Then, the multi-pin implanted body 40 is moved down so that the tips of the pins 41 abut on the fixed substrate 110. In this manner, the solutions are deposited on a surface of the substrate 110. After the solutions are deposited on the substrate 110, the multi-pin implanted body 40 is moved up.

In this case, for example, even a narrow pitch P of about 1 mm can be achieved easily by use of the method shown in FIG. 1.

FIG. 7 is a view showing a further method for depositing solutions. A plurality of chevron protrusions 61 are provided in a solution supplier 60. As shown in FIG. 7, solution reservoir portions 62 are formed in the protrusions 61 respectively. The solution reservoir portions 62 are formed so that solutions in the solution reservoir portions 62 are sucked up to tips of the protrusions 61 respectively by means using capillarity or the like.

The heights of the protrusions 61 are equalized so that all the tips of the protrusions 61 abut on a lower surface of the substrate 110 when the solution supply portion 60 is moved up. In this manner, the solutions can be spotted simultaneously on a plurality of places on the substrate 110.

As the method of depositing solutions, an ink jet method or electrostatic adsorption method deposition method may be used instead of the aforementioned mechanical contact method deposition method.

The solutions of biopolymers spotted on the substrate in the aforementioned manner may be transferred onto another substrate to produce an array of biopolymers newly.

What is claimed is:

1. A biochip production apparatus for forming an array of biopolymers on a substrate, comprising:
a substrate moving unit which moves the substrate up, down, left and right; and
a plurality of solution supply units which are disposed to be fixed, in which solutions containing biopolymers are stored, which deposit the solutions on the substrate.

2. The biochip production apparatus according to claim 1,
wherein when the solution supply units deposit the solutions on a predetermined position of the substrate, the substrate moving unit moves the substrate to a predetermined position.

3. The biochip production apparatus according to claim 1,
wherein the substrate moving unit has a stage, on which the substrate is disposed, which enables to move up, down, left and right.

4. The biochip production apparatus according to claim 1,
wherein each of the solution supply units stores solutions containing biopolymers different in kind, respectively.

5. The biochip production apparatus according to claim 1,
wherein the substrate is located in an upper or lower side of each solution supply unit.

6. The biochip production apparatus according to claim 1,
wherein each of the solution supply units has a syringe or a needle which enables to supply the solutions with using capillarity.

7. The biochip production apparatus according to claim 1,
wherein each of the solution supply units deposits the solutions on the substrate at a point or at multi-points.

8. The biochip production apparatus according to claim 7,
wherein a pitch of the multi-points on the substrate is not larger than 1 mm.

9. The biochip production apparatus according to claim 1,
wherein the solution supply units deposit the solutions on the substrate by a mechanical contact method, an ink jet method, or an electrostatic adsorption method.

10. A biochip production apparatus,
wherein solutions on a substrate deposited by another biochip production apparatus according to claim 1 are transferred onto another substrate to form an array of biopolymers.
